(19) United States
(12) Patent Application Publication
(10) Pub. No.: US 2012/0290423 A1
(43) Pub. Date: Nov. 15, 2012

(54) SYSTEM AND METHOD FOR MAKING RENTAL INVENTORY AVAILABLE FOR SALE

(75) Inventor: Eric J. Hoersten, Chicago, IL (US)

(73) Assignee: Redbox Automated Retail, LLC, Oak Brook Terrace, IL (US)

(21) Appl. No.: 13/372,271

(22) Filed: Feb. 13, 2012

Related U.S. Application Data
(60) Provisional application No. 61/442,601, filed on Feb. 14, 2011.

(51) Int. Cl. G06Q 20/20; G06Q 30/06

(52) U.S. Cl. 705/22

(57) ABSTRACT

A system and method for selling a rental media product having entertainment content therein via an automated vending machine are provided. The method receives a request from a user, the request identifying the rental media product, retrieves, from a database, product rental information relating to the rental media product, wherein the product rental information comprises a product release date, a last maximum out-of-rent value, a sold-out date value, and a current on-hand count, determines whether the product rental information satisfies a set of sales decision criteria, wherein the set of sales decision criteria includes a product release date threshold, a last maximum out-of-rent value threshold, a sold-out date requirement, and a current on-hand count threshold. The method further provides an offer to sell the rental media product if the plurality of sales decision criteria is satisfied, and vends the rental product from a vending apparatus to the user if the user accepts the offer for sale.

### CROSS-REFERENCE TO RELATED APPLICATION

This application claims priority to U.S. Patent Application No. 61/442,601, filed on Feb. 14, 2011, entitled “SYSTEM AND METHOD FOR MAKING RENTAL INVENTORY AVAILABLE FOR SALE”, and is incorporated herein by reference in its entirety.

### TECHNICAL FIELD

The invention relates to systems and methods for making rental media products having entertainment content therein available for sale. More particularly, the present invention provides a system and method for making rental inventory of media products available for sale by applying centrally defined rules at individual kiosks.

### BACKGROUND OF THE INVENTION

While the present invention is often described herein with reference to a digital video disc distribution system, an application to which the present invention is advantageously suited, it will be readily apparent that the present invention is not limited to that application and can be employed in vending systems used to distribute a wide variety of vending products. Typically, when vending systems, such as kiosks, are configured to provide or offer previously-rented inventory for sale, the available inventory is determined by selecting specific products for sale using system-wide criteria at periodic intervals, based on inventory on sales/demand projected. One such system disclosed within U.S. Patent Publication No. 2004/0158871 A1, to Greg Jacobson, issued on Aug. 12, 2004, is directed to an automated digital media bending apparatus. The discloses apparatus, not only prepares a replacement disk for dispensed disks, but will also use artificial intelligence and statistics regarding the demand and sales performance of the various titles to continually adjust inventory based upon anticipated future sales. U.S. Patent Publication No. 2004/0158871 A1 is incorporated herein by reference for at least the purpose of giving context to the present invention.

U.S. Patent Publication No. 2004/0068451 A1 to Edward C. Lenk is directed to a method and apparatus for managing demand and inventory. Preferred embodiments forecast future rental and sales demand for a given electronic media, such as a videogame, prior to the release of that electronic media to the general public. The forecast is based on the pre-release demand of the electronic media in that the future rental and sales demand is estimated from the rental and sales demand of previously released electronic media having similar pre-release demand. Furthermore, the preferred embodiments of the present invention allow registered members of a rental user group to keep rented units of the electronic media for a purchase price, which is dynamically controlled to minimize rental shortage and maximize profits. U.S. Patent Publication No. 2004/0068451 A1 is incorporated herein by reference for at least the purpose of giving context to the present invention.

However, in the prior systems and methods the associated product dispensing machines are not configured to determine the availability for sale of previously rented products and currently stored therein in response to in-person requests. The present invention is provided to provide advantages and aspects not provided by prior systems and methods of this type. A full discussion of the features and advantages of the present invention is deferred to the following detailed description, which proceeds with reference to the accompanying drawings.

### SUMMARY OF THE INVENTION

The present invention is directed to a system, method and apparatus for making rental inventory of media products available for sale by applying centrally defined rules at individual kiosks.

The present invention provides a method for selling a rental media product having entertainment content therein via an automated vending machine. The method receives a request from a user, the request identifying the rental media product, retrieves, from a database, product rental information relating to the rental media product, wherein the product rental information comprises a product release date, a last maximum out-of-rent value, a sold-out date value, and a current on-hand count, and determines whether the product rental information satisfies a set of sales decision criteria, wherein the set of sales decision criteria includes a product release date threshold, a last maximum out-of-rent value threshold, a sold-out date requirement, and a current on-hand count threshold. The method further provides an offer to sell the rental media product if the plurality of sales decision criteria is satisfied, and vends the rental product from a vending apparatus to the user if the user accepts the offer for sale.

The present invention provides a method for offering rental media products having entertainment content therein for sale via an automated vending machine. The method receives a request from a user to display rental media products contained in the automated vending machine that are available for sale, retrieves, from a database, product rental information relating to each of the rental media products contained in the automated vending machine, wherein the product rental information comprises for each of the rental media products a product release date, the largest number of copies of the rental media product that were simultaneously rented from the automated vending machine during the prior week, and an indication of how recently all copies of the rental media product were simultaneously rented out by the article vending machine for each rental media product, and determines, for each rental media product, whether the product rental information satisfies a set of sales decision criteria. The set of sales decision criteria is based on a product release date threshold, a threshold for the largest number of copies the rental media product that was simultaneously rented from the article vending machine during the prior week and a threshold based on how recently all copies of the rental media product were simultaneously rented out by the article vending machine. The method further provides a list of each rental media product that satisfies the sales decision criteria.

The present invention provides an automated vending machine for selling a rental media product having entertainment content therein. The vending machine includes a user interface configured to receive a request identifying the rental media product, a database containing product rental information relating to the rental media product. The product rental information includes a product release date, the largest number of copies of the rental media product that were simultaneously rented from the automated vending machine during the prior week, and an indication of how recently all copies of the rental media product were simultaneously rented out by the article vending machine. The vending machine further includes a sale determination application for comparing the product rental information to sales criteria contained within the sale determination application and, if the sales criteria is met, generating an offer to sell the rental media product via the user interface, wherein the user interface is further configured to receive an acceptance of the offer to sell the rental media product, and an opening for dispensing the sold rental media product to the user.

The present invention provides a system for selling a rental media product having entertainment content therein. The system includes an automated vending machine, which comprises a user interface configured to receive a request identifying the rental media product, to provide an offer to sell the rental media product, and to receive an acceptance of the offer to sell the rental media product, and an opening for dispensing the sold rental media product to the user. The System further includes a central server in communication with the automated vending machine, a database containing product rental information relating to the rental media product. wherein the product rental information comprises a product release date, the largest number of copies of the rental media product that were simultaneously rented from the automated vending machine during the prior week, and an indication of how recently all copies of the rental media product were simultaneously rented out by the automated vending machine, and a sale determination application for comparing the product rental information to sales criteria contained within the sale determination application.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of a system for communicating and processing information in a network of article dispensing machines and a remote control center in accordance with the principles of the present invention;

FIG. 2 is a perspective view of the article dispensing machine of FIG. 1;

FIG. 3 is a partially open perspective view of the article dispensing machine of FIG. 1;

FIG. 4 is a block diagram illustrating a plurality of peripheral devices of the article dispensing machine illustrated in FIG. 1;

FIG. 5 is a block diagram illustrating a method for making available for sale rental inventory at the article dispensing machine of FIG. 1 in accordance with the principles of the present invention;

FIG. 6 is a flow diagram illustrating a method for determining the availability for sale of a previously rented article by applying centrally defined rules at an article dispensing machine in accordance with the principles of the present invention;

FIG. 7 is a flow diagram illustrating a method for determining the “last maximum out for rent” value in accordance with the principles of the present invention;

FIG. 8 is a flow chart illustrating a method for determining the “sold-out date” value in accordance with the principles of the present invention; and

FIG. 9 is a flow chart illustrating a method for determining the availability for sale of previously rented articles system-wide in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is defined by the appended claims. This description summarizes some aspects of the present embodiments and should not be used to limit the claims.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

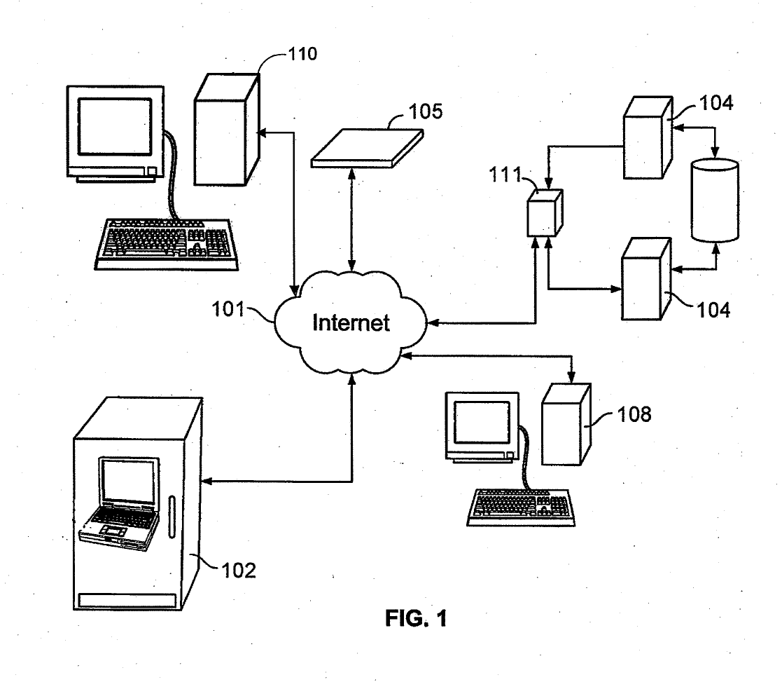

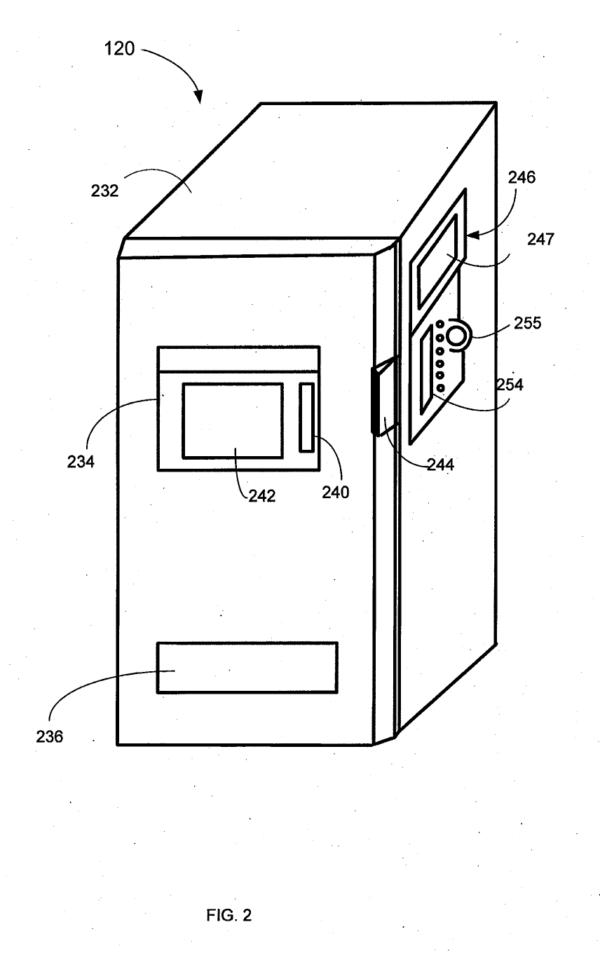

Referring now to FIGS. 1-3, a system diagram illustrating an embodiment of a networked system 100 in accordance with the principles of the present invention is shown. The networked system 100 includes an article dispensing machine 102, a plurality of central controllers 104, a financial server 105, and personal computers 108 and 110, all communicatively coupled to one another via a network 101, which can be a global network or a wide area network (WAN).

The article dispensing machine 102, which is preferably located remotely from the central controller 104, is described, in terms of functions and features, in detail among various other functions and features of the system 100 in U.S. patent application Ser. No. 11/408,789 ('789), filed on Apr. 4, 2006, the content of which is incorporated by reference herein in its entirety. It will be understood that as used herein, the terms “central controller” and “central server” are synonymous, and refer to a microprocessor operating computer software that is configured to perform the software tasks described herein.

Generally, in terms of hardware architecture the server 104 includes a processor and/or controller, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor/controller is a hardware device for executing software, particularly software stored in memory. Processor can be any custom made or commercially available processor, a central processing unit (CPU), an auxiliary processor among several processors associated with the server 104, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor may also represent a distributed processing architecture such as, but not limited to, SQL, Smalltalk, APL, KLisp, Snobol, Developer 200, MUMPS/Magic.

Memory can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor.

The software in memory may include one or more separate programs. The separate programs comprise ordered listings of executable instructions for implementing logical functions. The software in memory includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system essentially controls the execution of other computer programs and provides scheduling, input-output control, file and data management, memory management, and communication control and related services.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

If the server 104 is a PC, workstation, PDA, or the like, the software in the memory may further include a basic input output system (BIOS). The BIOS is a set of essential software routines that initialize and test hardware at startup, start the O/S, and support the transfer of data among the hardware devices. The BIOS is stored in ROM so that the BIOS can be executed when server 104 is activated. When server 104 is in operation, processor is configured to execute software stored within memory, to communicate data to and from memory, and to generally control operations of server 104 pursuant to the software. The present invention and the O/S, in whole or in part, but typically the latter, are read by processor, perhaps buffered within the processor, and then executed.

When the present invention is at least in part implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

For that purpose, article dispensing machine 102 is equipped with network communication equipment and circuitry. In a preferred embodiment, the network communication equipment includes a network card such as an Ethernet card. In a preferred network environment, each of the plurality of article dispensing machines 102 on the network is configured to use the TCP/IP protocol to communicate via the network 101. It will be understood, however, that a variety of network protocols could also be employed, such as IPX/SPX, Netware, PPP and others. It will also be understood that while a preferred embodiment of the present invention is for article dispensing machine 102 to have a “broadband” connection to the network 101, the principles of the present invention are also practicable with a dialup connection using a standard modem. Wireless network connections are also contemplated, such as wireless Ethernet, satellite, infrared and radio frequency networks.

The central controller 104 is responsible for communicating with the vending controller 106 via the network 101. The central controller 104 is preferably located at a central station that is remote from the plurality of article dispensing machines 102. The central controller 104 operates as the server for communicating over the network 101 between the plurality of article dispensing machines 102. The central controller 104 receives communication from the article dispensing machines 102, and also transmits information to the machines 102. For example, when a DVD rental or sale transaction is performed at the article dispensing machine 102, transaction data such as the rented or sold DVD title is then transmitted from the machine 102 to the central controller 104 via the network 101. It will be understood that servers in general, such as the central controller 104, are often distributed.

As shown in FIG. 1, there is preferably a plurality of central controllers 104. Thus, the controllers 104 are arranged in a “load balanced” architecture to improve the speed and efficiency of the network. To accomplish the implementation of multiple controllers 104, the controllers 104 are in communication with a router/distributor 111. The router 111 receives communication from the network 101, and distributes the communication to one of the plurality of controllers 104. Likewise, when one of the controllers 104 transmits information, that information is received by the router 111 and then transmitted to the network 101.

The central controller 104 is in communication with a central database 113. The database 113 stores information regarding the transaction network. For example, the database 113 stores data regarding the vending inventory at each of the plurality of article dispensing machines 102. The database 113 also stores sales information regarding the sales quantities of the vending merchandise stored in the machines 102. For example, the database 113 stores information regarding the sales totals for each DVD title and for each machine 30 vending location. Database 113 also stores user information and rental transaction information, such as user IDs, PINs, the date on which DVDs are due to be returned and the date on which DVDs were rented from the machines 102.

Database 113 is preferably a relational database, although other types of database architectures may be used without departing from the principles of the present invention. For example, database 113 may be a SQL database, an Access database or an Oracle database, and in any such embodiment have the functionality stored herein. Database 113 is also preferably capable of being shared, as illustrated, between a plurality of central controllers 104 and its information is also preferably capable of being transmitted via network 101. It will be understood that a variety of methods exist for serving the information stored in database 113, such as ODBC, MySQL and CFML.

The central controller 104 and database 113 are also preferably accessible by personal computers 108 and 110. Each of the personal computers 108, 110 will be understood as comprising hardware and software consistent with marketable personal computers, such as a display monitor, a keyboard and mouse and a microprocessor. Personal computers 108 and 110 also comprise Internet browser software such as Mozilla or Internet Explorer. Using the browser software, a user at one of personal computer 108 and 110 can access a web interface through the central controller 104. To that end, central controller 104 preferably comprises web server software such as IIS or Apache. It will be understood that a variety of web server software and web browser software exists to implement the principles of the present invention without departing therefrom. Through the web browser software, personal computer 108 and 110 can communicate with the central controller 104 and allows the user to login to a central command functionality of the central controller 104 and to view and modify data stored in the database 113. The browser interface also allows the user to perform certain system functions, which will affect the inventory and behavior of the article dispensing machines 102.

In a preferred embodiment, a financial server 105 is also in communication with the network 101. It will be understood that a variety of financial services exist for processing financial information via the Internet and other networks 101. Those services allow for the processing of credit card and debit card information, so that users of the services do not have to interface directly with credit and debit card companies. In FIG. 1, the financial server 105 is illustrated as a single server, although the financial server 105 may comprise an entire sub-network of financial servers 105 responsible for processing financial information.

When a user interfaces with the article dispensing machine 102 and provides financial information such as a credit card number, that information is transmitted from the machine 102 via the network 101. In one embodiment, the financial information is transmitted directly from the machine 102 to the financial server 105. In another embodiment, the information is transmitted to the central controller 104 first, and is then transmitted to the financial server 105. In either of those embodiments, financial server 105 is responsible for processing the financial information received from the user at the article dispensing machine 102. In another embodiment, financial server 105 software is comprised in the central controller 104, and financial transactions are performed by the central controller 104 without a separate financial server 105.

Referring to FIG. 2, the article dispensing machine 102 includes a cabinet housing 232 with front, rear, top, bottom, and side panels. Article dispensing machine 102 further includes a user interface portion 234 and an article transport storage unit transfer opening 236. The user interface portion 234 of cabinet housing 232 preferably includes a card reader 240, a display monitor 242 and an article transfer opening 244. The card reader 240 is preferably designed in known fashion to read magnetically encoded membership and/or credit cards for authorizing the distribution of articles of inventory through the article transfer opening 244. Display monitor 242 permits customers, users and/or inventory stocking personnel to communicate with the dispensing machine 102 and/or a central office linked in electrical communication with the dispensing machine 102. Display monitor 242 also permits users, customers and/or inventory stocking personnel to enter appropriate commands directed to carrying out specific machine tasks. Display monitor 242 provides for a user interface presenting visual display of pertinent information during the servicing and distribution processes of dispensing machine 102. Display monitor 242 preferably incorporates known plasma video technology and known touch screen technology. As such, display monitor 242 preferably operates as a user interface for entry of commands designed to carry out machine tasks. Optionally, a keypad can be included to permit all or some of those functions to be carried out.

Additionally, known audio technology could be incorporated within article dispensing machine 102. Preferably, known audio technology is incorporated within dispensing machine 102 to broadcast focused audio directed to relatively small (e.g., 3 square feet) locations in front of the machines and/or in other designated locations at a hosting site. Furthermore, it will be appreciated that additional user interface portions having additional or even identical user interface components could be incorporated within article dispensing machine 102. For example, these components could be incorporated on other panels of the housing 232 of machine 102 so that the machine can be used simultaneously by multiple customers, translating into more efficient distribution of articles in high traffic areas.

In a preferred application, article dispensing machine 102 is a DVD dispensing machine that can be utilized by consumers to purchase and/or rent movie videos and/or video games embodied on DVD discs. Nonetheless, those skilled in the art will appreciate that article dispensing machine 102 is not limited to the application of DVD distribution, but rather will have applicability for use in the distribution of a variety of articles.

In particular, the display monitor of the dispensing machine 102 preferably incorporates known touch screen technology. As such, it provides for a user interface presenting visual display of pertinent information during the servicing and distribution processes of machine 102 and operates as a user interface for entry of commands designed to carry out machine tasks.

The dispensing machine 102 may preferably include an additional display monitor (not shown), which preferably incorporates known plasma video technology and provides for display of trailers, advertisements and other desired point-of-purchase video effects.

Furthermore, article dispensing machine 102 incorporates an additional user interface portion 246, having additional user interface components. User interface portion 246 is shown incorporated on a side panel of housing 232 so that machine 102 can be used simultaneously by multiple consumers, translating into more efficient exchange of media articles between users and machine 102 of media articles in high traffic areas. Alternately, user interface portion 246 could be incorporated on any other location of housing 232. Additional details about and method of use of user interface portion 246 will be discussed hereafter following discussions of other elements of article dispensing machine 102. The user interface portion 246 includes a display monitor and touch screen 247, an article return opening or return slot 254, and a return button 255. Display monitor 247 permits consumers and/or inventory stocking personnel to communicate with dispensing machine 102 and/or a central office linked in electrical communication with dispensing machine 102. Display monitor 247 also permits consumers and/or inventory stocking personnel to enter appropriate commands directed to carrying out specific machine tasks. Display monitor 247 preferably incorporates known plasma or LCD video technology and known display monitor technology. When pressed by a user, return button 255 is configured to communicate a signal to a processor (not shown) indicating a desire of the user to return a previously rented article, which might have been dispensed by article dispensing machine 102 or by any other dispensing machines that is part of the network of article dispensing machine 102.

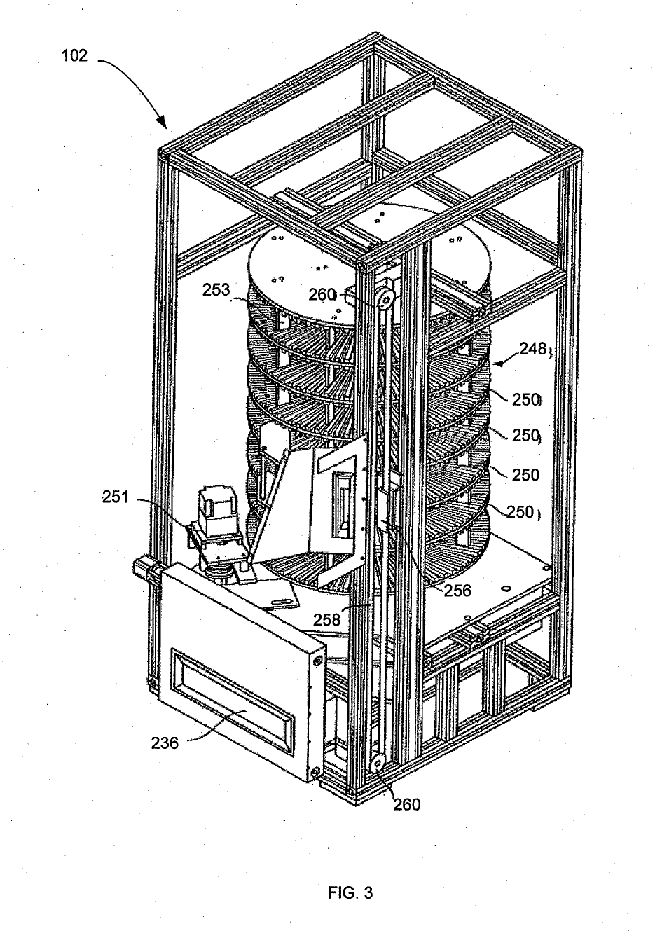

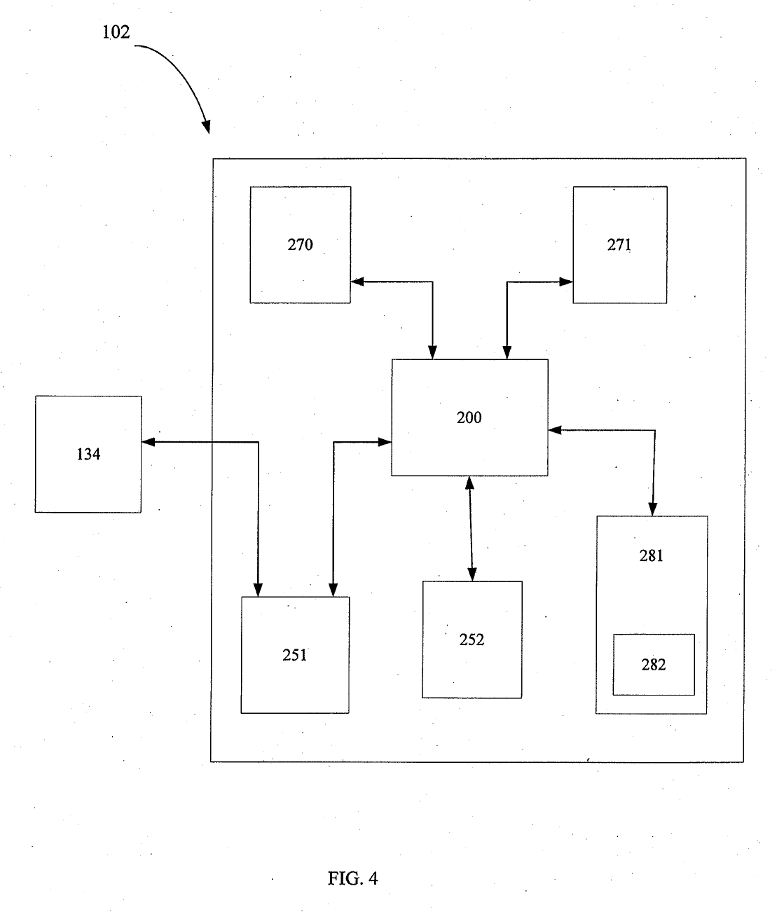

Referring now FIGS. 3 and 4, components positioned in the interior of dispensing machine 102 are illustrated. Machine 102 includes a storage rack unit 248 having a plurality of circular-shaped storage racks 250 sharing a common central axis. A motor 251 is configured to drive a shaft (not shown), which is positioned along the common central axis of storage rack unit 248 to provide for rotation of the storage racks 250, as desired. Wheels (not shown) are included to receive a belt used to rotate the wheels and, in turn, rotate the shaft.

Each storage rack 250 includes radially extending, angularly separated compartment panels defining article receiving compartments designed to receive and retain flat-type pack articles, such as DVD cases, as desired. The compartment panels are preferably axially aligned to retain the opposing sides of DVD cases at the top and bottom ends thereof. In that regard, the DVD cases are preferably retained between successive vertical pairs of storage racks 250. The storage racks 250 are vertically spaced by axially extending support members 253. The dispensing machine includes a robotic arm 256 that is connected to a conveying belt 258 carried by rollers 260. At least one of the rollers 260 is driven by a motor to provide for movement of robotic arm 256.

As shown in FIG. 4, each article dispensing machine 102 includes a dispensing machine processor or vending controller 200, which is connected to a first sensor 270 and second a second sensor 271, the first motor 251, a second motor 252 and the user interface control system 134, collectively referred to as “the peripheral devices.” The vending controller 200 is capable of executing various programs to provide input to and receive outputs from the peripheral devices. The vending controller 200 is responsible for generating user interfaces displayed on display screens 242 and 247, processing commands received from user interfaces, displaying information to a user, communicating with the vending network, and dispensing articles. Suitable processors for such use are known to those of skill in the art. In addition, the vending controller 200 is operably connected to at least one memory storage device 281, such as a hard-drive or flash-drive or other suitable memory storage device.

Article dispensing machine memory storage device 281 can include anyone or a

combination of volatile memory elements (e.g., random access memory (RAM, such as DRAM, SRAM, SDRAM, etc.)) and nonvolatile memory elements (e.g., ROM, hard drive, tape; CDROM, etc.). Moreover, article dispensing machine memory storage device 281 may

incorporate electronic, magnetic, optical, and/or other types of storage media. Article dispensing machine memory storage device 281 can have a distributed architecture where various components are situated remote from one another, but are still accessed by processor. Article dispensing machine memory storage device 281 includes an article dispensing machine database 282, which stores information regarding, among other things, the inventory of the article dispensing machine including the position of each article within the inventory of the article dispensing machine.

Vending controller 200 is configured to transmit information to, and receive information from, the network 101. While the Internet is the preferred network method for interconnecting the network 101 with the plurality of article dispensing machines 102, it will also be understood that a private or closed network is also practicable herewith. The network 101 is preferably the Internet, but may be any network for placing the plurality of article dispensing machines 102 in communication with the central controller 104. The network 101 serves to communicate information regarding vending transactions, and is also therefore referred to herein as a “transaction network,” though as used herein, the terms “network” and “transaction network” are synonymous. For the present invention, the vending controller 200 is further configured to include a sale determination application for comparing the product rental information to sales criteria contained within the sale determination application and, if the sales criteria is met, generating an offer to sell the rental media product via the user interface.

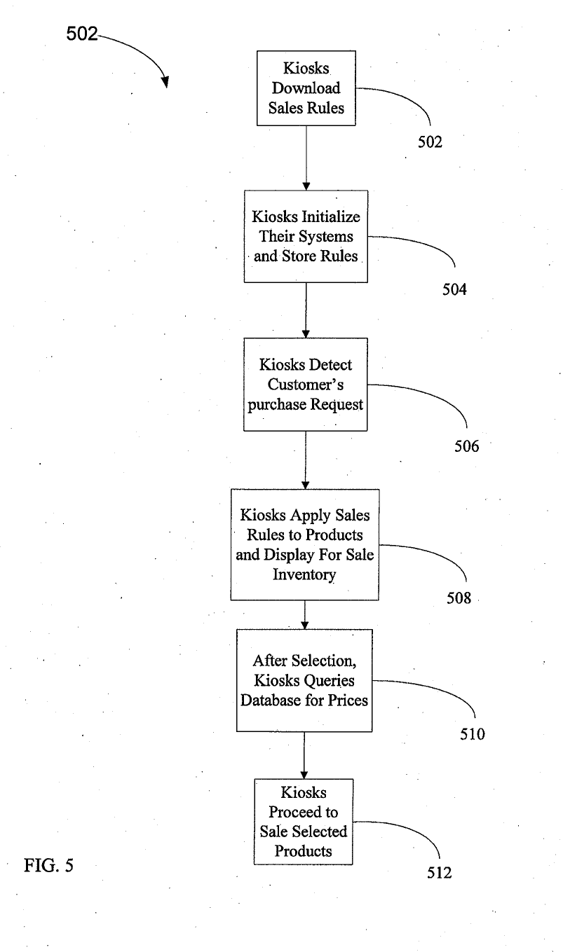

Now referring to FIG. 5, a block diagram 500 illustrates an embodiment of a method for making available for sale a media rental inventory. In order to maintain an optimal rental inventory of media products at individual article dispensing machines or kiosks 102, the balance of product selection and profit needs to be optimized. This optimal balance can be accomplished by offering less profitable rental articles or products for sale based on predetermined sales decision criteria or rules, which take into account inventories and rental histories at individual kiosks 102. The predetermined sales rules are configured to allow each kiosk 102 to intelligently adjust the inventory available for sale at the time of access by a customer by reviewing the rental history of its current inventory. The predetermined sales rules can further be adjusted for individual kiosks 102 or groups of kiosks 102. The predetermined sales rules are initially centrally stored at the servers 104 and database 113, to be provided to the kiosks 102, upon request by the kiosks 102 or after having been modified to provide the most recent version of the sales rules to the participating kiosks, at step 502. After receiving the new or updated sales rules, the kiosks 102 are configured to reinitialize their internal systems, by for example storing the new rules or substituting the old rules with the newly updated ones in their respective memories 281 and databases 282, while maintaining their respective operations as normal, at Step 504. The respective memories 281 and databases 282 serve to store product information including, but not limited to, the title, the genre, the release date, and rental history of each copy of the product. When a customer, indicates through the interface 234, at Step 506, a desire to browse a kiosk's selection of previously rented inventory available for sale, the vending controller 200 retrieves product information for each stored product from database 282, applies the sales rules to each product of the inventory, and displays the resulting optimal for-sale inventory to the customer, at Step 508. Once the customer makes a product selection from the displayed for-sale list or inventory, the vending controller 200 queries the databases 113 and 282 or the controller 104 for suggested sale prices, at Step 510. Upon receipt of the suggested purchase prices, the vending controller 200 generates an interface screen instructing the customer via the interface 234 to provide payment by, for example, swiping a credit card on record via the card reader 240 for authorizing the distribution of the selected product or products through the article transfer opening 244, at Step 512.

The sales decision criteria or rules can be configured by the purchasing department, which typically decides which and how many media products or digital video discs (DVD) are purchased and which of these media products can be offered for sale after suitable rental histories. Alternately, any other entity associated with the DVD rental and sale business can generate these sales rules that help kiosks 102 determine which products can be offered for sale. The purchased media products are initially registered into central servers 104 and the database 113, via a proprietary application called “Hive.” The Hive application can also be configured to determine and to mark particular media products as sell-thru products, and this sell-thru marking is duplicated down to the participating kiosks 102. The sales rules, that need to be provided to each individual participating kiosk 102 and applied to each media product in order to qualify as a for-sale or sell-thru product, hereafter referred to as “Out For Rent” (OFR) rules, are as follows:

The kiosk 102 has been in operation at its present location for at least a specific period of time, i.e., an in-operation period threshold.

The release date of the product needs to be older than a predetermined number of days, i.e., a product release date threshold.

The media product needs to have a rental history at the kiosk 102.

The media product needs to have a “last maximum out for rent” (LMOFR) value, which is set periodically, for example once a week, based on the highest number of simultaneous out-for-rent copies of the same title during the value-setting period, i.e., a LMOFR value threshold.

The media product needs to have an empty “sold-out date” (SOD) value, which is set when the product's on-hand quantity or count reaches zero (0) at any time during a preset prior period. The “sold-out date” value is set to empty or zero (0) if the on-hand copies of the media product does not reach zero at any time during the preset prior period. Alternately, a near sold-out date (NSOD) value may be required for the media product to qualify as a for-sale product. That is, the product's on-hand quantity at any time during the preset prior period needs only to reach the value of one (1) or two (2), for example, rather than zero.

The media product's current on-hand count of copies is more than last week's maximum out-for-rent count.

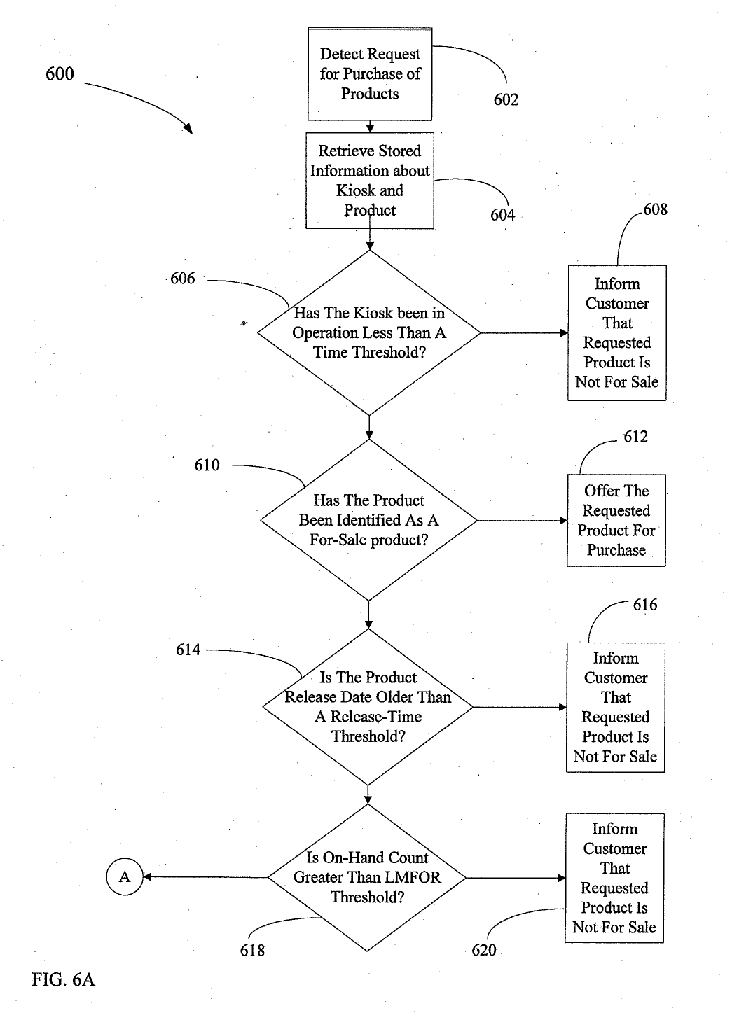

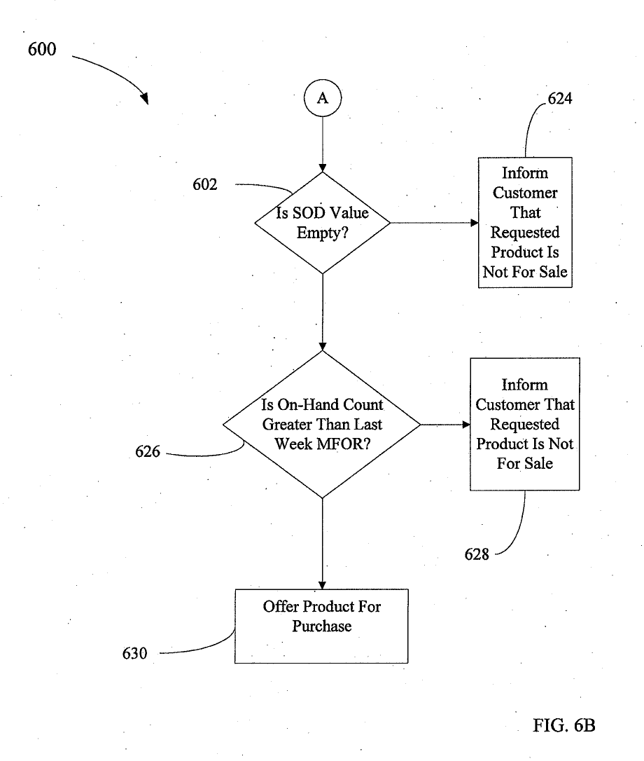

Now referring to FIG. 6, a flow diagram 600 illustrates a method for determining the availability for sale of a previously rented currently-in-stock product by applying the centrally defined OFR rules in accordance with the principles of the present invention. Upon detection, at Step 602, via the interface 134, of a request by a customer to purchase a particular media product from the corresponding kiosk 102, the vending controller 200 queries the memory 281 and/or the database 282 to retrieve the stored information about the kiosk 102 and about the requested product, and the OFR rules, at Step 604. Subsequently, the vending controller 200 determines whether the kiosk 102 has been in-operation longer that the associated in-operation period threshold, say for example sixty (60) days, at Step 606. Upon determination that the kiosk 102 has not been operating for at least the in-operation period threshold, the vending controller 200 generates an interface screen indicating to the customer that the desired product is not for sale, at Step 608. Otherwise, the vending controller 200 determines whether the requested product has previously been determined to be available for purchase, at Step 610. In the affirmative, the vending controller 200 generates another interface screen to inform that the desired product is available for purchase, at Step 612, and proceeds to initiate the process for selling the product by requesting payment information before authorizing the distribution of the purchased product through the transfer opening 144. Otherwise, the vending controller 200 proceeds to determine whether the product's release date, by the corresponding video or DVD releasing company, is older that the associated product release date threshold, for example 29 days, at Step 614. In the negative, the vending controller 200 generates another interface screen to inform the customer that the desired product is not available for purchase, at Step 616. Otherwise, the vending controller 200 proceeds to determine whether the current number or count of on-hand copies of the requested product is equal or greater than the current LMOFR value threshold for the requested product, at Step 618. If the current number of on-hand copies is found to be greater than the current LMOFR value threshold, then the vending controller 200 generates another interface screen indicating to the customer that the requested product is not available for sale, at Step 620. Otherwise, if the current number of on-hand copies is found to be less than the current LMOFR value threshold, then the vending controller 200 determines whether the requested product has an empty or a zero SOD value reached at any time during the preset prior period, at Step 622. In the affirmative, the vending controller 200 generates another interface screen indicating to the customer that the requested product is not available for sale, at Step 624. Otherwise, the vending controller 200 determines whether the current on-hand quantity of copies of the requested product is greater than last week's maximum out-for-rent count, at Step 626. In the affirmative, the vending controller 200 generates another interface screen indicating to the customer that the requested product is not available for sale, at Step 628. Otherwise, the vending controller 200 generates an alternate interface screen to indicate to the customer that the requested product is available for sale, queries the databases 113 and 282 or the controller 104 for a suggested sale price, and proceed to initiate the operations needed to accomplish the purchase and to authorize the distribution of the purchased product through the transfer opening 144, at Step 630. Whenever the requested product is found to be not available for sale during the above-discussed process, the vending controller 200 can be configured to propose to the customer an alternate product, of the same genre for example, which may have been determined for a prior purchase request to be available for sale or for which the OFR rules needs to be evaluated to determine whether the alternate product qualifies as a for-sale product.

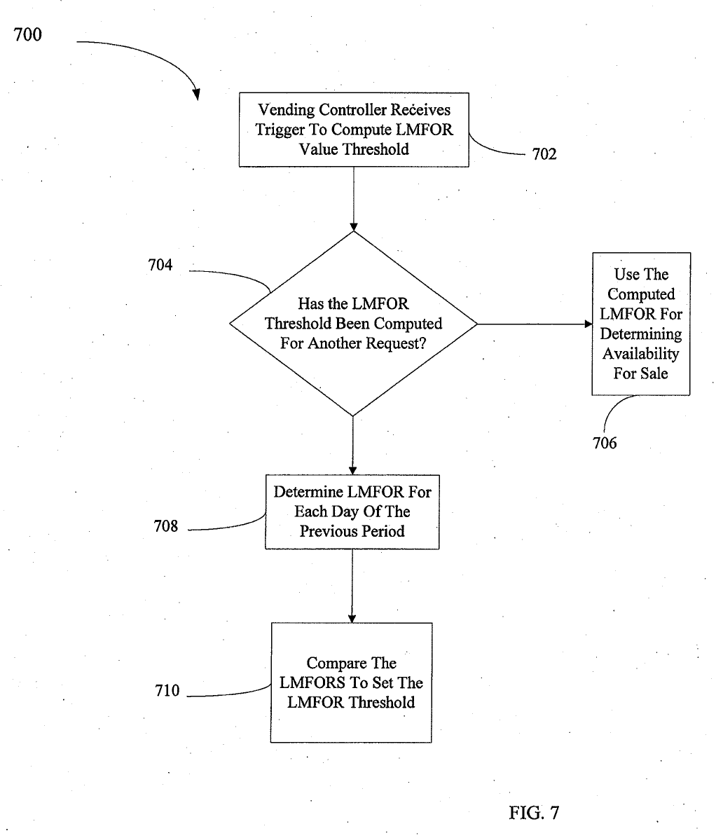

Now referring to FIG. 7, a flow chart 700 illustrates an embodiment of the method or process for evaluating the LMOFR value of a rental product for a predetermined value-setting period, say for example last week. As indicated above, to be considered or to qualify as an available for-sale product, the on-hand quantity of copies of the same title product at the time of the purchase request needs to be compared to a LMOFR value threshold. The vending controller 200 can be triggered to evaluate the LFMOR value threshold of each rental product title on a predetermined timetable or whenever a particular product is the subject of a purchase request, at Step 702. Once triggered, the vending controller 200 retrieves the rules for computing the LFMOR value threshold from the memory 281 or from the database 282, and checks whether the LFMOR value has already been determined for the desired fixed prior period, for example last week, at Step 704. In the affirmative, the already evaluated LFMOR value is saved in the memory 281 and/or database 282 as the LFMOR value threshold, at Step 706. Otherwise, the vending controller 200 determines the LMOFR value for each day of the desired fixed prior period, at Step 708, and proceeds to compare the plurality of LMOFR values to one another so as to determine the largest LMOFR value, to be set as the LMOFR value threshold for the desired fixed prior period, at Step 710.

Alternately, instead of evaluating the LMOFR value threshold for a fixed prior period, for example last week, the LMOFR value threshold can be evaluated for a moving prior period that starts backward from the day of the purchase request, i.e., a moving window or period of time, for example the last seven (7) days.

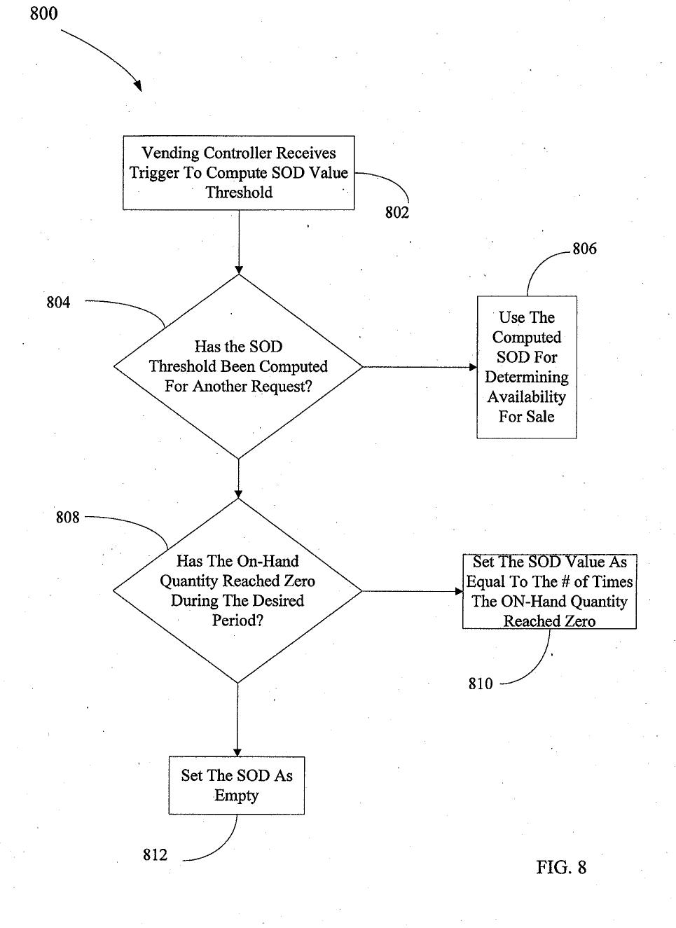

Now referring to FIG. 8, a flow chart 800 illustrates an embodiment of the method or process for evaluating the SOD value of a rental product for a predetermined value-setting period, say for example last week. As indicated above, to be considered or to qualify as an available for-sale product, the desired product needs to have an empty SOD value during a predetermined fixed prior period. The vending controller 200 can be triggered to evaluate the SOD value of each rental product title on a predetermined timetable or whenever a particular product is the subject of a purchase request, at Step 802. Once triggered, the vending controller 200 retrieves the rules for computing the SOD value from the memory 281 or from the database 282, and checks whether the SOD value has already been determined for the desired fixed prior period, for example last week, at Step 804. In the affirmative, the already evaluated SOD value is saved in the memory 281 and/or database 282, at Step 806, to be used for the determination of whether the desired product is available for sale. Otherwise, the vending controller 200 determined whether the on-hand quantity of the desired product had reached zero at any time during the fixed prior period, at Step 808. In the negative, the SOD value is set as empty, at Step 810. Otherwise, the SOD value is set as the number of times the on-hand quantity of the desired product had reached zero during the fixed prior period, at Step 812.

Alternately, instead of evaluating the SOD value once for a fixed prior period, for example last week, the SOD value can be evaluated for a moving prior period that starts backward from the day of the purchase request, i.e., a moving window or period of time, for example the last seven (7) days.

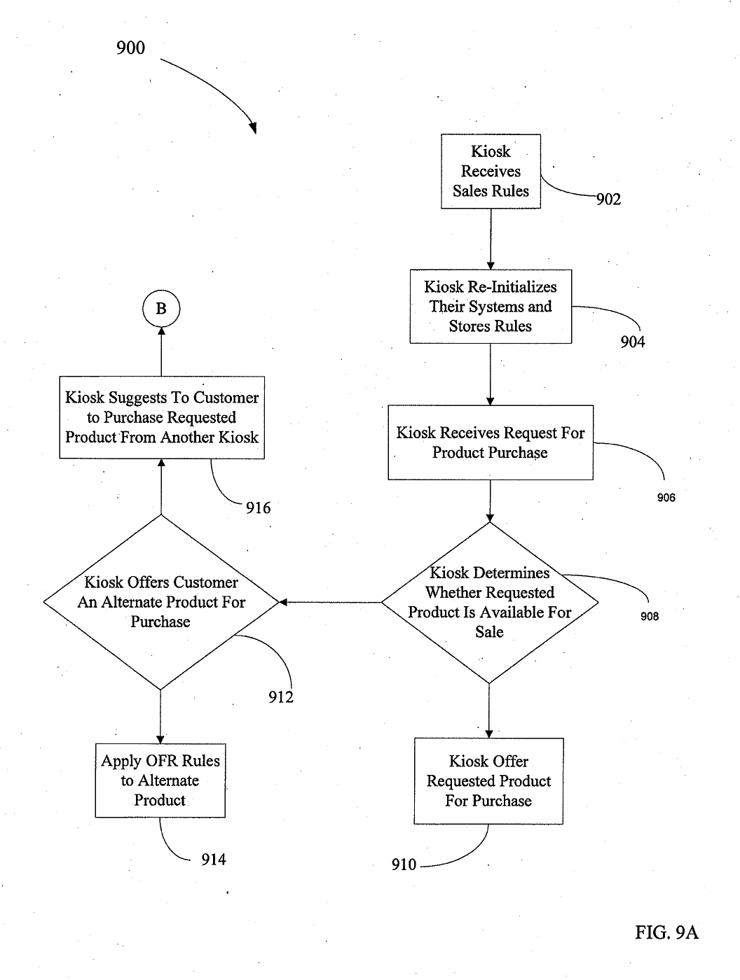

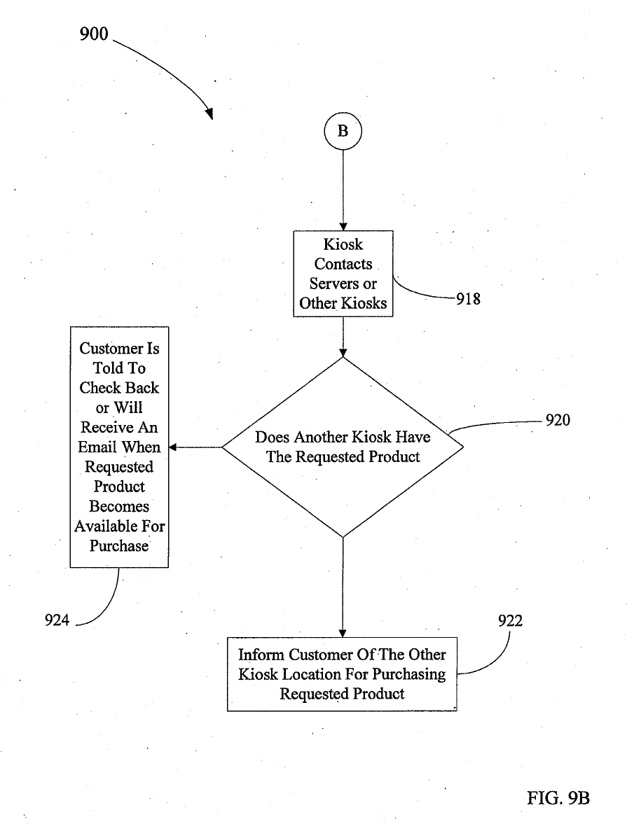

Now referring to FIG. 9, a block diagram 900 illustrates an alternate embodiment of a method for making available for sale a media product system-wide. As discussed above in reference to FIG. 5, after receiving the new or updated OFR rules, at Step 902, the kiosks 102 are configured to reinitialize their internal systems, by for example storing the new OFR rules or substituting the old OFR rules by the newly updated ones in their respective memories 281 and databases 282, while maintaining their respective operations as normal, at Step 904. When a customer indicates through the interface 234 a request to purchase a particular product available for sale, the vending controller 200 detects the request, at Step 906, at and applies the provided OFR rules to the requested product, at Step 908, as detailed above in the discussion of FIG. 6, to determine whether the requested product is available for purchase. In the affirmative, the vending controller 200 generates an interface screen indicating that the requested product can be purchased, at Step 910. In the negative, the vending controller 200 determines whether another product, of the same genre for example, satisfies the OFR rules to be offered as an alternate product for purchase by the customer, at Step 912. In the affirmative, the vending controller 200 generates an interface screen indicating that the alternate product can be purchased, at Step 914. In case the customer declines purchasing the alternate product, the vending controller 200 can propose via an interface screen to the customer whether he/she is willing to visit another kiosk 102 if the requested product is found to be available for purchase at the other kiosk 102, at Step 916. If the customer acquiesces to the proposal, the vending controller communicates with one of the servers 104 to inquire whether alternate kiosks 102 might be tapped for the availability for sale of the requested product, at Step 918. The alternate kiosks 102 will be considered based on their proximity to the customer's stored residential data and/or on his/her geographical pattern of kiosk visits. Upon receiving a positive result to the inquiry from the one of the servers 104, at Step 920, the vending controller 200 generates another interface screen to inform the location of the other kiosk 102 from which the requested product can be purchased, at Step 922. Otherwise, the vending controller 102 generates another interface screen asking the customer to check back in the near future because based on its rental history the requested product might become available for sale, or informing the customer that an email can be send to inform him/her when the requested product becomes available for sale, at Step 924.

Alternately, the customer may access, from the personal PC 108 or 110, a website associated with the system 100 and maintained by one of the controllers or servers 104, for example, to request the purchase of a rental media product. Upon detection of the purchase request, one of the controller 104 identifies which ones of the plurality of kiosks 102, having the requested product in stock, are geographically convenient to the customer to have them check whether the requested product qualifies as a for-sale product. Upon receiving information from a subset of the identified kiosks 102 that the requested product qualifies as a for-sale product, the controller 104 generates an interface screen informing the customer of the subset of identified kiosks 102 that can be visited to purchase the requested product.

Any process descriptions or blocks in figures represented in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While the specific embodiments have been illustrated and described, numerous modifications come to mind without significantly departing from the spirit of the invention, and the scope of protection is only limited by the scope of the accompanying Claims.

What is claimed is:

1. A method for selling a rental media product having entertainment content therein via an automated vending machine, comprising the steps of:
receiving a request from a user, the request identifying the rental media product;
retrieving, from a database, product rental information relating to the rental media product, wherein the product rental information comprises a product release date, a last maximum out-of-rent value, a sold-out date value, and a current on-hand count;
determining whether the product rental information satisfies a set of sales decision criteria, wherein the set of sales decision criteria includes a product release date threshold, a last maximum out-of-rent value threshold, a sold-out date requirement, and a current on-hand count threshold;
providing an offer to sell the rental media product if the plurality of sales decision criteria is satisfied; and
vending the rental product from a vending apparatus to the user if the user accepts the offer for sale.

2. The method of claim 1, further comprising the step of:
retrieving from a database, article vending machine information relating to the article vending machine including the amount of time the kiosk has been in operation at its present location; and
determining whether the article vending machine information satisfies the sales decision criteria, wherein the sales decision criteria further includes a date the kiosk opened threshold.

3. The method of claim 1, wherein the current on-hand count threshold is equal to the max out-for-rent count of a predetermined prior period.

4. The method of claim 1, wherein the sold-out date value requirement is that the sold-out date value be empty and wherein the sold-out date value is set to empty if the quantity does not reach zero at any time during a predetermined prior period.

5. The method of claim 1, further comprising the step of:
querying a database to determine whether the rental product has been marked for sale.

6. The method of claim 5, further comprising the step of:
querying a database to determine a sale price for the rental product.

7. The method of claim 1, further comprising the step of:
receiving a user identification from the user interface.

8. A method for selling a rental media product having entertainment content therein via an automated vending machine, comprising the steps of:
receiving a request from a user, the request identifying the rental media product;
retrieving, from a database, product rental information relating to the rental media product, wherein the product rental information comprises a product release date, the largest number of copies of the rental media product that were simultaneously rented from the automated vending machine during a prior period, and an indication of how recently all copies of the rental media product were simultaneously rented out by the article vending machine;
determining whether the product rental information satisfies a set of sales decision criteria, wherein the set of sales decision criteria is based on a product release date threshold, a threshold for the largest number of copies the rental media product that was simultaneously rented from the article vending machine during the prior week and a threshold based on how recently all copies of the rental media product were simultaneously rented out by the article vending machine;
providing an offer to sell the rental media product if the plurality of sales decision criteria is satisfied; and
vending the rental product from a vending apparatus to the user if the user accepts the offer for sale.

9. The method of claim 8, further comprising the step of:
retrieving from a database, an identifier of the amount of time that the automated vending machine has been in operation; and
determining whether the identifier of the amount of time that the automated vending machine has been in operation satisfies an automated vending machine operation threshold.

10. The method of claim 8, wherein the automated vending machine operation threshold is sixty days.

11. A method for offering rental media products having entertainment content therein for sale via an automated vending machine, comprising the steps of:
receiving a request from a user to display rental media products contained in the automated vending machine that are available for sale;
retrieving, from a database, product rental information relating to each of the rental media products contained in the automated vending machine, wherein the product rental information comprises for each of the rental media products a product release date, the largest number of copies of the rental media product that were simultaneously rented from the automated vending machine during the prior week, and an indication of how recently all copies of the rental media product were simultaneously rented out by the article vending machine for each rental media product;
determining, for each rental media product, whether the product rental information satisfies a set of sales decision criteria, wherein the set of sales decision criteria is based on a product release date threshold, a threshold for the largest number of copies the rental media product that was simultaneously rented from the article vending machine during the prior week and a threshold based on how recently all copies of the rental media product were simultaneously rented out by the article vending machine; and
providing a list of each rental media product that satisfies the sales decision criteria.

12. An automated vending machine for selling a rental media product having entertainment content therein, the automated vending machine comprising:
a user interface configured to receive a request identifying the rental media product;
a database containing product rental information relating to the rental media product. wherein the product rental information comprises a product release date, the largest number of copies of the rental media product that were simultaneously rented from the automated vending machine during the prior week, and an indication of how recently all copies of the rental media product were simultaneously rented out by the article vending machine;
a sale determination application for comparing the product rental information to sales criteria contained within the sale determination application and, if the sales criteria is met, generating an offer to sell the rental media product via the user interface, wherein the user interface is further configured to receive an acceptance of the offer to sell the rental media product; and
an opening for dispensing the sold rental media product to the user.

13. A system for selling a rental media product having entertainment content therein, the system comprising:
an automated vending machine comprising:
a user interface configured to receive a request identifying the rental media product, to provide an offer to sell the rental media product, and to receive an acceptance of the offer to sell the rental media product; and
an opening for dispensing the sold rental media product to the user;
a central server in communication with the automated vending machine,
a database containing product rental information relating to the rental media product. wherein the product rental information comprises a product release date, the largest number of copies of the rental media product that were simultaneously rented from the automated vending machine during the prior week, and an indication of how recently all copies of the rental media product were simultaneously rented out by the automated vending machine; and
a sale determination application for comparing the product rental information to sales criteria contained within the sale determination application.
